(19) United States
(12) Patent Application Publication
(10) Pub. No.: US 2025/0248411 A1
(43) Pub. Date: Aug. 7, 2025

(54) FEEDING DEVICE FOR FEEDING A CHAIN OF SAUSAGES TO A PROCESSING DEVICE

(71) Applicant: VEMAG Maschinenbau GmbH, Verden (DE)

(72) Inventors: Thorsten Meininger, Verden (DE); Peter Knodel, Oyten (DE); Denise Albrecht, Verden (DE)

(21) Appl. No.: 19/046,765

(22) Filed: Feb. 6, 2025

(30) Foreign Application Priority Data
Feb. 6, 2024 (DE) 102024103327.4

(51) Int. Cl. A22C 11/00; B65G 15/14; B65G 47/18

(52) U.S. Cl. CPC A22C 11/008; B65G 47/18; B65G 15/14; B65G 2201/0202

(57) ABSTRACT

A feed apparatus is provided for feeding a link of sausages to an apparatus for further processing the link of sausages. The feed apparatus includes a frame and a feeder element arranged on the frame for feeding the link of sausages to the further processing apparatus. The feeder element has a surface on which the link of sausages lies during operation and is moved in a feeding direction towards the further processing apparatus. The surface of the feeder element is funnel-shaped and concave, such that the sausages, as they move in the feeding direction, are deflected inwards, relative to the feeding direction, from the peripheral areas of the surface, in sections at least.

### CROSS-REFERENCE TO RELATED APPLICATION

This application claims priority to German Patent Application No. 102024103327.4, filed Feb. 6, 2024. The above-mentioned patent application is incorporated herein by reference in its entirety.

### TECHNICAL FIELD

The invention relates to a feed apparatus for feeding a link of sausages composed of a plurality of sausages to an apparatus that further processes the link of sausages, comprising a frame, and a feeder element, arranged on the frame, for feeding the link of sausages, wherein the feeder element has a surface on which the link of sausages lies during operation and is moved in a feeding direction towards the further processing apparatus. The invention also relates to an apparatus for further processing a link of sausages, comprising at least one conveyor which takes delivery of the link of sausages and conveys them in a conveying direction, and a feed apparatus arranged upstream from the conveyor.

### BACKGROUND

Such feed apparatuses, on which a link of sausages composed of a plurality of interlinked sausages is normally placed by hand, are used in the prior art to feed a link of sausages to a further processing apparatus. In many cases, depositing tables are used that have at least a frame and a feeder element provided in the form of a table plate on the frame. The feeder element has a planar surface on which the link of sausages is deposited before being fed to the further processing apparatus.

In order to feed the link of sausages to the further processing apparatus, one end of the link of sausages is fed downstream from the feed apparatus to a conveyor of the further processing apparatus, which moves the link of sausages down from the feed apparatus at a predefined conveying speed. The link of sausages is often deposited on the feed apparatus in a meandering pattern, in which two or three sausages are oriented on the surface of the feeder element one after the other and transversely to the actual feeding direction in multiple rows. When feeding the link of sausages that have been put down in a meandering pattern or in loops, jolting forces of acceleration arise at each loop end, which is usually arranged off-center in relation to the feeding direction and therefore radially spaced-apart from the actual direction in which the link of sausages are being fed, with the result that transverse forces act on the loop end that impose a relatively heavy strain on the twist points between the individual sausages in the link of sausages. This strain may suffice by itself to rupture the twist point between two sausages.

Furthermore, due to the transverse forces acting at an angle to the feeding direction when moving the link of sausages on the feeder element, the link of sausages may wobble back and forth about the actual feeding direction, with the result that the end face of a sausage may collide with the conveyor for conveying the link of sausages. This further increases the risk of a rupture at a twist point of the link of sausages.

The object of the invention as therefore to improve a feed apparatus of the kind initially specified in such a way that the disadvantages described above are avoided. In particular, the object of the invention is to specify a feed apparatus which improves how a link of sausages is fed to a further processing apparatus.

### SUMMARY

The invention achieves its object with a feed apparatus having the features of claim 1, for feeding a link of sausages to an apparatus that further processes the link of sausages. In particular, the surface of the feeder element is funnel-shaped and concave such that, as they move in the feeding direction, the sausages are deflected inwards relative to the feeding direction, in particular radially, from peripheral areas of the surface, at least in sections.

By providing such a surface designed according to the invention, the approach pursued by the present invention is that the peripheral (lateral) areas of the surface support the deflection of the sausages towards the feeding direction, which is determined in particular by the conveyor of the further processing apparatus, by feeding them on the funnel-shaped and concavely shaped surface. The funnel-shaped and concavely shaped surface of the feeder element, in particular its peripheral areas, advantageously reduces the back and forth movement of the link of sausages about the feeding direction. Indeed, the funnel shape and concave shape of the surface counteracts any further radially outward movement of the sausages in relation to the feeding direction. At the least, the feeder element surface designed according to the invention also reduces the risk of a collision between an end face of the sausages and a conveyor conveying the link of sausages.

According to a preferred development of the feed apparatus, the peripheral areas of the surface become increasingly steep in the feeding direction, such that the sausages in the link of sausages are increasingly deflected or guided inwards, in particular radially, due to the increasing steepness. The transverse forces acting on the sausages are counteracted in particular by the ever-steeper peripheral or lateral areas of the feeder element surface that receives the link of sausages. The force of gravity also supports the deflection of the sausages towards the feeding direction when the link of sausages is being moved. In one embodiment of the invention, the peripheral areas of the surface are also raised higher in the feeding direction, in addition to their increasing steepness.

According to a development of the feed apparatus, the surface of the feeder element defines a feed cross-section which extends substantially transversely to the feeding direction and which progressively decreases in the feeding direction, at least in sections. By means of the feed cross-section that extends transversely to the feeding direction and becomes narrower in the feeding direction, the link of sausages that is put down onto the surface of the feeder element, in particular in a meandering pattern, is preferably guided supportively and laterally. A feed cross-section that progressively decreases in width is to be understood as lateral narrowing of the peripheral areas or upper boundary of the feeder element. Within the meaning of the invention, the feed cross-section is upwardly bounded by an imaginary line running between two upper lateral edges of the peripheral areas of the feeder element surface. In combination with the funnel shape and concave shape of the preferably upwardly open surface of the feeder element, the feeding movement of the link of sausages is laterally stabilized in such a way that when the link of sausages leaves the feeder element, it preferably moves congruently with the feeding direction that is preferably achieved by means of the feeder element according to the invention. It would also be in accordance with the invention if the feed cross-section of the feeder element were upwardly limited by means of a lid, not shown, or by an upper wall, for example.

The feed cross-section of the feeder element, as defined by its surface, is preferably substantially U-shaped along at least one section in the feeding direction. By means of the U-shape of the upwardly open surface on the feeder element, the feeding movement of the link of sausages in the feeding direction can preferably be stabilized in a simple and efficient manner. Disadvantageous transverse forces, or the risk of contact between the end of a sausage and the conveyor, can be advantageously reduced to a minimum.

In a preferred embodiment of the feed apparatus, the surface of the feeder element forms an upwardly open feed hopper that narrows in the feeding direction at least along a section in the feeding direction, wherein the surface is preferably substantially step-free. Designing at least a section of the feeder element surface as an upwardly open feed hopper is a structurally or constructively simple way of designing a feeder element. The link of sausages can simply be placed at one end of the open feed hopper in a meandering pattern and its feeding movement is stabilized in the lateral direction by the decreasing feed cross-section of the hopper until the link of sausages is transferred to the conveyor of the further processing apparatus. An upwardly open feed hopper also allows the feeding movement of the link of sausages to be visually monitored. Any disruptions while the link of sausages is being fed can be detected quickly and easily, and any counter-measures that are necessary can be initiated immediately. The preferably step-free design of the surface, i.e., without any edges or steps, also makes it easier for the link of sausages to slide down the feeder element.

According to a preferred development of the feed apparatus, the feed cross-section defined by the surface of the feeder element is formed at least in some areas by a radius which decreases in the feeding direction. By providing a radius that primarily determines the feed cross-section defining the surface of the feeder element, a simple option is created for designing a funnel-shaped, concave and above all step-free surface that regularizes and stabilizes the feeding movement of the link of sausages in the feeding direction.

According to a preferred embodiment, the width of the surface, measured at its upper boundary, also decreases at least in sections in the feeding direction, and/or the radius forming the feed cross-section in some areas decreases continuously in the feeding direction. The surface preferably decreasing in width, or the radius that continuously decreases in the feeding direction of the feeder element, supports and improves the deflection of the loop ends of the link of sausages put down in a meandering pattern and transversely to the feeding direction of the feeder element, and thus fosters a uniform feeding movement in the feeding direction of the feeder element. Due to this continuous decrease, the gradual narrowing of the feed cross-section at the feeder element is implemented, wherein the entire surface on the feeder element is preferably designed free of steps, which makes it even easier for the link of sausages to slide down the surface of the feeder element. In this embodiment, the width of the upwardly open surface is defined by a fictitious connecting line between the upper boundary or the peripheral areas, which preferably also determines the upper boundary line for the feed cross-section defined by the surface.

In a preferred embodiment of the feed apparatus, the surface has a substantially straight, a convexly curved and/or a concavely curved profile along one section in the feeding direction. In one embodiment, the funnel-shaped and concave surface of the feeder element has a straight profile in the feeding direction itself. This means that sections of the feeder element surface preferably have an identical gradient in the feeding direction. In an optional or alternative embodiment, sections of the funnel-shaped and concave surface of the feeder element may also have a convexly and/or concavely curved profile. Starting from the receiving area of the feeder element and proceeding towards the dispensing area, the surface may have an increasing and/or decreasing gradient in the feeding direction and may therefore be given convex and/or concave curvatures.

According to a development of the feed apparatus, the surface of the feeder element defines, at least in sections, a first receiving area in the feeding direction for receiving the link of sausages. The receiving area simplifies placement of the link of sausages to be placed preferably in loops or in a meandering pattern onto the feeder element. The link of sausages to be fed by means of the feeder element of the further processing apparatus is placed, in particular, in loops running transversely to the feeding direction of the feeder element. A loop of the link of sausages may consist, for example, or two or three sausages placed next to each other in a row, with the sausages immediately adjacent to the end of a loop then being turned by approximately 180° so that they are arranged in the opposite direction.

According to a preferred embodiment, the receiving area is substantially planar or has a concave curvature, at least transversely to the feeding direction, which preferably has a radius greater than 1 meter. This ensures that the link of sausages placed in loops can be deposited reliably on the receiving area of the feeder element surface. Starting from the receiving area having a minimum radius of 1 meter, preferably more than 2 meters, the width or radius of the feed cross-section decreases in the feeding direction preferably as far as the dispensing area of the feeder element.

According to a preferred embodiment, the surface defines a dispensing area for dispensing the link of sausages and which has the smallest width or the smallest feed cross-section. This ensures that the link of sausages deposited in the receiving area is centered in the feeding direction when it reaches the dispensing area and is dispensed to a further processing apparatus downstream from the feed apparatus. Any transverse accelerations acting on the link of sausages, in particular on their twist points, are reduced to a minimum. This means that the strain on the link of sausages is reduced overall and that any rupturing in the area of a twist point is advantageously avoided.

Even though it has the smallest width or the smallest feed cross-section, the dispensing area is preferably designed as the highest vertical point compared to the upstream sections of the feeder element surface in the feeding direction. The difference in height between the peripheral areas of the surface and a funnel-shaped, concave bottom end of the surface forming the center in the feeding direction is preferably at its greatest in the dispensing area. In contrast to the width of the feed cross-section, the feed cross-section increases in size in the vertical direction. In particular, the width and height of the feed cross-section are perpendicular to each other and each extend substantially perpendicular to the feeding direction of the link of sausages on the feeder element.

In addition to the concave curvature of the surface, two lateral wall sections extending substantially parallel to each other are preferably provided in the dispensing area. With the aid of the parallel wall sections, the dispensing area in particular is laterally bounded and preferably increased in height. The wall sections of increasing height simplify the process of transferring the link of sausages into an infeed area of a downstream conveyor of the further processing apparatus, for example. Transverse accelerations of the link of sausages are reduced by means of the lateral wall areas, thus preventing contact between the end surfaces of the sausages in the link of sausages with the conveyor and hence preventing any adverse effects on a twist point between two sausages. It is preferable that the wall sections are at a distance from other that is equal to about double the radius of the associated concavely curved surface connecting the wall sections to each other. A step-free transition is formed between the concavely curved surface and the planar wall sections adjoining it.

According to a preferred embodiment, the wall sections in the dispensing area are spaced apart from each other by a distance that is greater than the diameter of the sausages to be fed into it, and less than the center-to-center distance between two conveyor elements of a conveyor of the further processing apparatus downstream from the feeder element, wherein the conveyor elements define an infeed area for the link of sausages on the further processing apparatus. Maintaining a minimum distance between the wall sections ensures that the link of sausages can be moved via the feeder element towards the dispensing area with little friction and with reduced force. The maximum distance between the two parallel lateral wall sections is determined by the conveyor provided downstream in the feeding direction, however. The maximum distance is less, in particular a third less, than the center-to-center distance between the conveyor elements of the conveyor provided downstream from the dispensing area of the feeder element. Especially when feeding the link of sausages to the conveyor, the result is that a sausage reaching the infeed area of the conveyor is met in the infeed area by what is already a sufficiently narrowed section which gently receives the sausage in question.

In a development of the feed apparatus, the surface of the feeder element rises from the receiving area in the direction of the dispensing area. When moving the link of sausages on the surface of the feeder element, the result is that the remaining loops of the link of sausages in the receiving area do not move autonomously in the direction of the dispensing area. What happens, instead, is that feeding causes the link of sausages to be straightened out, which advantageously affects the deflection of the initially transversely extending sausages towards the actual feeding direction to be achieved by means of the feeder element. The surface between the receiving area and the dispensing area preferably has an angle of elevation a that is less than 10°. This means that, despite the positive upward gradient between the receiving area and the dispensing area, a relatively small additional tractive force is necessary to move the link of sausages, yet has no effect on the twist points between the interlinked sausages in the link of sausages.

According to a preferred development relating not only to a separate, second aspect essential to the invention but also to an optional embodiment of the feed apparatus, the feeder element has a structured surface which preferably forms a support surface having a reduced coefficient of friction for the link of sausages. By means of the structured surface of the feeder element according to the invention, the coefficient of friction of the support surface for the link of sausages is preferably reduced to such an extent that the tensile strain on the twist points is reduced to a minimum when the link of sausages is moved in the feeding direction on the surface of the feeder element. Simply by providing the structured surface, the coefficient of friction between the feeder element and the link of sausages can be reduced in such a way that any rupturing of the twist points between the sausages in the link of sausages is reliably prevented, despite the transverse accelerations acting when moving the link of sausages deposited in loops. In combination with the funnel-shaped and concave surface on the feeder element, the peripheral areas of which cause the sausages to be deflected inwards when moving the link of sausages in the feeding direction, the tensile strain on the link of sausages and in particular on their twist points is greatly reduced to such an extent that, by means of such a feeder element designed according to the invention, a link of sausages placed therein can always be fed reliably to any downstream apparatus.

According to a preferred embodiment, the structured surface has protrusions and/or indentations on the surface of the feeder element serving as a support surface for the link of sausages. The surface structure in the form of protrusions and/or indentations makes it easier for the link of sausages to slide down on the feeder element. With the aid of the protrusions and/or indentations produced, structurations are created that minimize the area in direct contact with the link of sausages. At the same time, the friction between the link of sausages and the surface of the feeder element is reduced, thus further reducing the tensile strain on the connecting areas, in the form of twist points, between the sausages in the link of sausages.

According to a development of the feed apparatus, the surface has structurations selected from the group: honeycombs, grooves, pyramids, nubs and combinations thereof. Providing a honeycomb, grooved, pyramid or nub structure, or where relevant a combination of the different structures along a surface section of the feeder element, is a simple and effective way to form a structured surface and to reduce the friction between the feeder element and the link of sausages to be moved thereon. The purpose of the structurations provided on the surface is primarily to minimize the contact surface between the feeder element and the link of sausages to be moved on and along it.

In one possible embodiment of the feed apparatus, the surface is provided with a coating that reduces its coefficient of friction, and/or a lubricant is applied to the surface during operation. With the aid of the surface coating and/or the lubricant applied to the surface, the friction between the surface of the feeder element and the link of sausages lying thereon and movable along it can be further reduced. A lubricant coating, for example, the purpose of which is to reduce friction and at the same time any potential wear and tear on the surface of the feeder element, can be used as the coating. A defined coefficient of friction with minimal variance can also be achieved by means of the lubricant coating.

The lubricant optionally or alternatively applied to the surface, in particular the liquid lubricant, produces an additional sliding layer between the surface of the feeder element and the interlinked sausages in the link of sausages. In the simplest case, the lubricant used can be a film of water, for example, by means of which the coefficient of friction can also be further reduced.

The feeder element is preferably made of a flat belt material, wherein the entire feeder element is designed in the shape of a funnel with a width that decreases in the feeding direction of the sausages. Providing a flat belt material is a structurally simple way of producing a preferably funnel-shaped and concave surface for receiving the link of sausages and along which the link of sausages to be fed to the further processing apparatus can be moved with little effort and thus with little strain on the twist points interlinking the sausages. Using a belt material also allows the entire feeder element to be brought into a kind of funnel shape, rather than just the funnel-shaped, concave surface, such that the feeder element has a concave curvature on its upper side that receives the link of sausages, or at least in a direction of extension, in particular transversely to the feeding direction of the link of sausages. The feeder element preferably has a width that decreases in the feeding direction of the link of sausages, wherein the curvature or radius of curvature of the feeder element decreases in the feeding direction. This creates peripheral areas on the surface that become increasingly steeper in the feeding direction, with the result that sausages in the link of sausages are deflected radially inwards to an increasing degree due to the increasing steepness of the peripheral areas.

According to one possible preferred embodiment of the feed apparatus, the feeder element is made of an elastically and/or plastically deformable material, in particular plastic, stainless steel or a composite material. Using an elastically and/or plastically deformable material has the advantage that the feeder element can be brought relatively easily into the required shape to obtain the necessary funnel-shaped, concave surface serving as a support surface for the link of sausages. The material used, which is preferably food-safe and has the necessary properties for ease of cleaning in the field of food technology, can be plastic, stainless steel or a composite material, for example.

Alternatively, the feeder element may also be made of a solid material, instead of a flat belt material, with the respective funnel-shaped and concave surface being created in the solid material, for example with the aid of machining methods.

Another aspect of the invention relates to an apparatus for further processing a link of sausages, comprising at least one conveyor which takes over the link of sausages and conveys them in a conveying direction, and a feed apparatus arranged upstream from the conveyor. The further processing apparatus also achieves the object of the feed apparatus according to the invention, by the feed apparatus being designed according to the preferred embodiments described above. Thus, the apparatus for further processing a link of sausages likewise has a feed apparatus comprising a frame and a feeder element, arranged on the frame, for feeding sausages interlinked to form a link of sausages to the further processing apparatus, the surface of the feeder element being funnel-shaped and concave and adapted to deflect the sausages radially inwards, in relation to the feeding direction, from peripheral areas of the surface, at least in sections.

The invention according to the third aspect makes use of the same advantages as the feed apparatus according to the first and second aspects. Preferred embodiments and developments of the first and second aspect of the invention are at the same time embodiments and developments of the further processing apparatus according to the third aspect, and vice versa, so, to avoid repetition, reference is made in that respect to the above observations concerning the feed apparatus.

### BRIEF DESCRIPTION OF THE DRAWINGS

The invention shall now be described in greater detail with reference to a preferred embodiment and the attached Figures, in which:

FIG. 1: shows a perspective view of an apparatus for further processing a link of sausages, including an embodiment of a feed apparatus according to the invention;

FIG. 2: shows a top view of the feed apparatus according to the invention shown in FIG. 1;

FIG. 3: shows a perspective view of a detail of the feed apparatus shown in FIG. 1;

FIG. 4: shows a front view of the feed apparatus according to the invention;

FIG. 5: shows a side view of the feed apparatus according to the invention;

FIG. 6: shows a front view of a second embodiment of a feed apparatus according to the invention, and

FIGS. 7-10: show perspective views of different embodiments of the surface on the feed apparatus.

### DETAILED DESCRIPTION

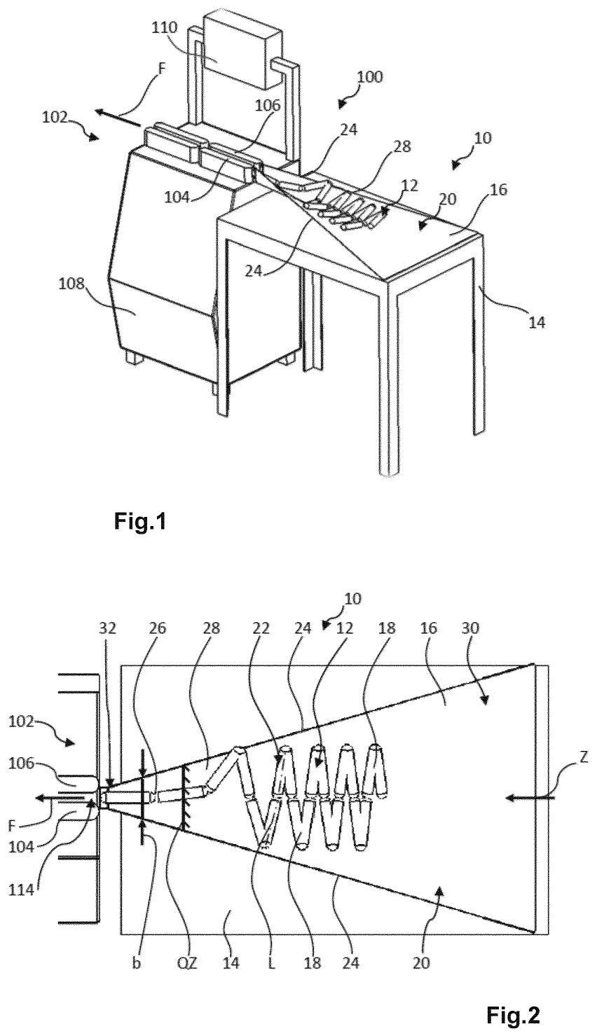

FIG. 1 shows an apparatus 100 for further processing a link of sausages 12 composed of a plurality of sausages 18, having a conveyor 102 comprising a plurality of conveyor elements 104, 106 and which takes delivery of the link of sausages 12 and conveys them in a conveying direction F. Apparatus 100 has a housing 108 on which conveyor 102 with its conveyor elements 104, 106 is arranged. Apparatus 100 also includes a control unit 110 in signal communication with conveyor 102 in order to control conveyor elements 104, 106. Control unit 110 has an operating display panel, not shown in further detail, for setting respective process data and parameters.

A feed apparatus 10 for feeding the link of sausages 12 to apparatus 100 for further processing the link of sausages 12 is arranged upstream at conveyor 102. Feed apparatus 10 includes a frame 14, which can also be regarded as a kind of housing, and arranged on frame 14 a feeder element 16 for feeding the link of sausages 12, composed of interlinked sausages 18, to conveyor 102. In the embodiment shown here, frame 14 is in the form of a supporting table.

Feeder element 16 arranged on frame 14 has a surface 20 on which the link of sausages 12 lies during operation of apparatus 10 and on which it is moved in a feeding direction Z towards further processing apparatus 100. In this embodiment, feeding direction Z and conveying direction F are coaxially aligned.

As can be seen from FIGS. 1 and 2, the link of sausages 12 composed of sausages 18 is placed in a meandering pattern on the surface 20 of feeder element 16 in such a way that sausages 18 are oriented approximately transversely to the feeding direction Z of the link of sausages 12 towards conveyor 102. Here, two sausages 18 laid one after the other in a row form an approximately straight section 22 of the supported link of sausages 12. When the link of sausages 12 is moved in feeding direction Z, the respective ends of the straight portions 22 of the link of sausages 12 laid in a meandering pattern are accelerated transversely to the actual feeding direction Z. In order to reduce the forces acting on the link of sausages 12 during transverse acceleration, the invention specifies that the surface 20 of feeder element 16 is funnel-shaped and concave, such that the sausages 18 are deflected radially inwards, in relation to feeding direction Z, from peripheral areas 24 of surface 20, at least in sections.

In a preferred embodiment, the peripheral areas 24 of surface 20 become increasingly steeper in feeding direction Z. Due to the increasing steepness of the peripheral areas 24 of its surface 20, feeder element 16 is so adapted with its respectively shaped surface 20 that the sausages 18 are increasingly deflected radially inwards in relation to feeding direction Z. Due to peripheral areas 24 becoming increasingly steeper, the force of gravity has a supporting effect on the movement of the sausages 18; the tensile strain on the link of sausages 12 and in particular on the twist points 26 linking the individual sausages 18 to each other is reduced as a result.

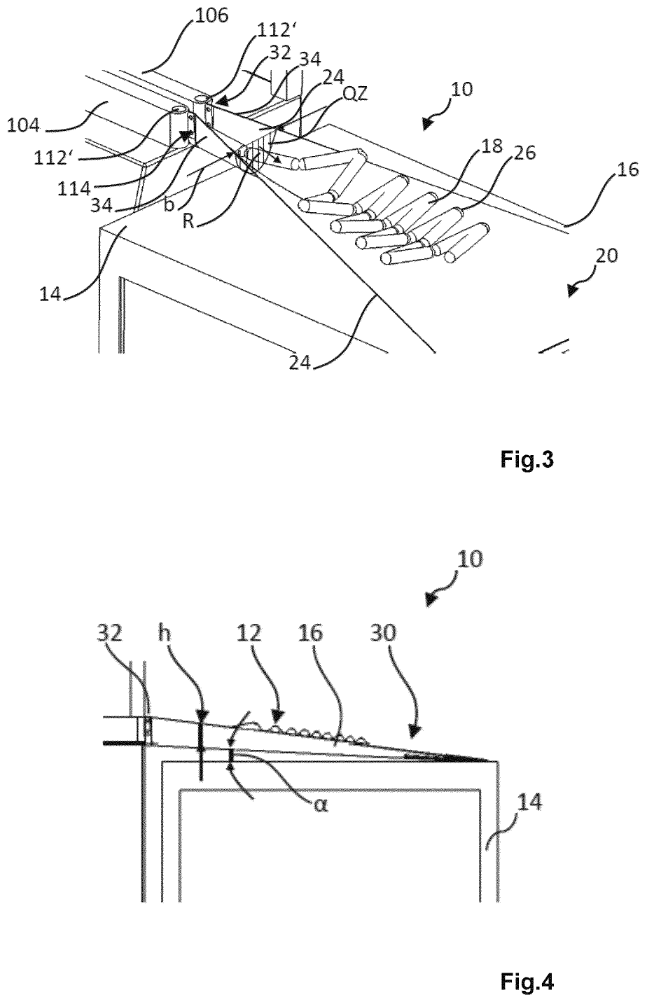

As can be seen from the detail shown in FIG. 3, the surface 20 of feeder element 16 defines a feed cross-section Q_{Z} that extends substantially transversely to feeding direction Z. Within the meaning of the invention, feed cross-section Q_{Z} is upwardly bounded by an imaginary line running between the two upper lateral edges of the peripheral areas 24 of surface 20 of feeder element 16. It can be seen from FIG. 3, for example, that at the location shown, the imaginary line of width b limits feed cross-section Q_{Z} in the upward direction, whereas the surface 20 of feeder element 16 limits or defines feed cross-section Q_{Z} laterally and in the downward direction.

Viewed in feeding direction Z, feed cross-section Q_{Z} at the first end of surface 20 of feeder element 16 is relatively small or even zero, and then becomes larger initially. Viewed along the further course of feeding direction Z, in particular from about half way along feeder element 16, 16′, feed cross-section Q_{Z} then decreases towards dispensing area 32. The width b of surface 20 decreases over the entire length of feeder element 16, 16′, whereas the height h of the lateral edges of peripheral areas 24 increases. It would also be in accordance with the invention if feed cross-section Q_{Z} were upwardly limited by a lid, not shown, or by an upper wall.

As FIG. 3 further illustrates, the width of feed cross-section Q_{Z} decreases in feeding direction Z, i.e., between the peripheral areas 24 that determine the width b of feeder element 16. In a special embodiment of the invention, feed cross-section Q_{Z} is substantially U-shaped along at least one section in feeding direction Z.

In the embodiment shown here, the surface 20 of feeder element 16 forms an upwardly open feed hopper 28 that narrows in feeding direction Z, at least along a section in feeding direction Z. As FIG. 3 also shows, the feed cross-section Q_{Z} defined by the surface 20 of feeder element 16 is formed at least partially by a radius R. In the embodiment shown here, radius R decreases in the feeding direction.

In sections at least, feeder element 16 has a receiving area 30 on which the link of sausages 12 can be placed. In the embodiment of feeder element 16 shown here, receiving area 30 has a concave curvature, transversely to feeding direction Z at least, which curvature has a radius R greater than 1 meter and preferably greater than 2 meters.

Feeder element 16 also has a dispensing area 32, defined by surface 20, for dispensing the link of sausages 12 and which has the smallest width b or the smallest feed cross-section Q_{Z} in the width direction of feeder element 16. In particular, the dispensing area 32 of surface 20 for the link of sausages 12 is U-shaped. As can also be seen from FIG. 3, two lateral wall sections 34 extending substantially parallel to each other are preferably provided in dispensing area 32, in addition to the concave curvature of the surface 20. Wall sections 34 are at a distance A from other that is equal to about double the radius of the associated concavely curved surface 20 connecting wall sections 34 to each other.

According to one embodiment of the invention, wall sections 34 are at a distance A from each other that is greater than the diameter of the link of sausages 12 and less than a center-to-center distance between two deflection rolls 112, 112′ of conveyor 102, in particular of the two conveyor elements 104, 106 opposite one another which define an infeed area 114 on apparatus 100 for the link of sausages 12.

In a preferred embodiment, feed cross-section QZ, in relation to its width b, and/or radius R forming feed cross-section Q_{Z} in some areas, decreases continuously in feeding direction Z. In the embodiment shown here, the width b of feed cross-section Q_{Z} decreases gradually, such that there are no steps between the sections of surface 20 of feeder element 16 that are arranged one after the other in the feeding direction. Surface 20 is preferably step-free, therefore.

As shown by FIG. 4, the surface 20 of the feeder element rises from receiving area 30 in the direction of dispensing area 32. Starting from the receiving area 30 of feeder element 16 and proceeding towards dispensing area 32, surface 20 has a positive angle of elevation a of less than 10°. In the embodiment shown in FIG. 4, surface 20 also has a substantially straight profile with a constant upward gradient from receiving area 30 towards receiving area 30.

As can also be seen from FIG. 4, feeder element 16 has a height h which increases from receiving area 30 towards dispensing area 32. The feed cross-section Q_{Z} of surface 20 thus increases in the vertical direction from receiving area 30 towards dispensing area 32, and is limited in each case by the upper edges of peripheral areas 24.

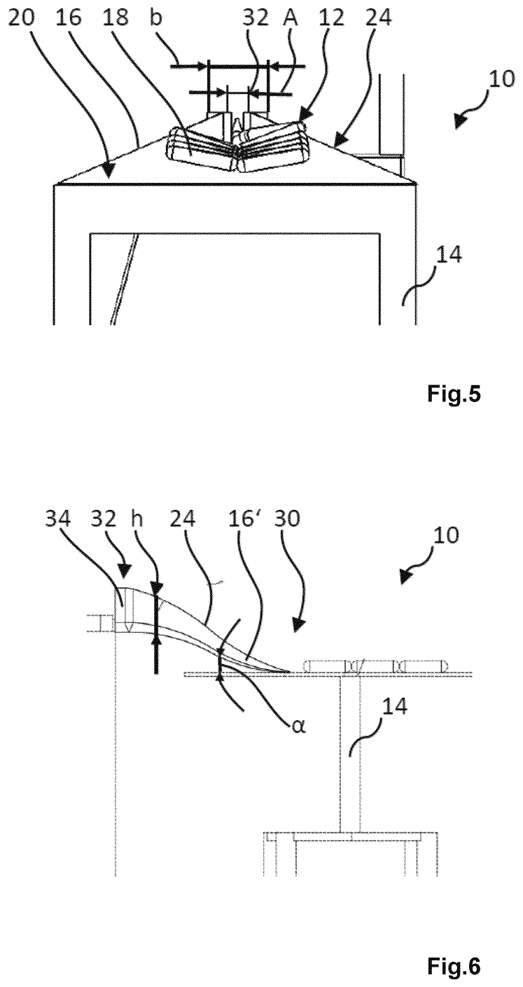

FIG. 5 shows a side view of feed apparatus 10 and thus in the feeding direction Z of the link of sausages. FIG. 5 illustrates the inventive design of feeder element 16 with its peripheral areas 24 that become increasingly steeper from receiving area 30 towards dispensing area 32, and which support the deflection of the sausages 18 lying in receiving area 30, whose longitudinal axes L are still approximately transverse to the feeding direction Z of the link of sausages 12 to further processing apparatus 100, during the feeding movement of the link of sausages 12 towards the dispensing area 32.

FIG. 6 shows an alternative embodiment of a feed apparatus 10′, which has the basic design of the feed apparatus 10 described in FIGS. 1 to 5. In contrast to the embodiment described above, feed apparatus 10′ includes a feeder element 16′ having a surface 20 with a concavely and/or convexly curved profile along a section in feeding direction Z. The surface 20 of feeder element 16′ on feed apparatus 10′ also has a profile, therefore, that rises in height from receiving area 30 towards dispensing area 32. The angle of elevation a of surface 20 of feeder element 16′ is likewise positive, but the upward gradient of surface 20 varies in the feeding direction with an angle of 0° to 10°.

Receiving area 30 on feeder element 16′ is also substantially planar, so surface 20 has an uncurved profile, transversely to feeding direction Z at least.

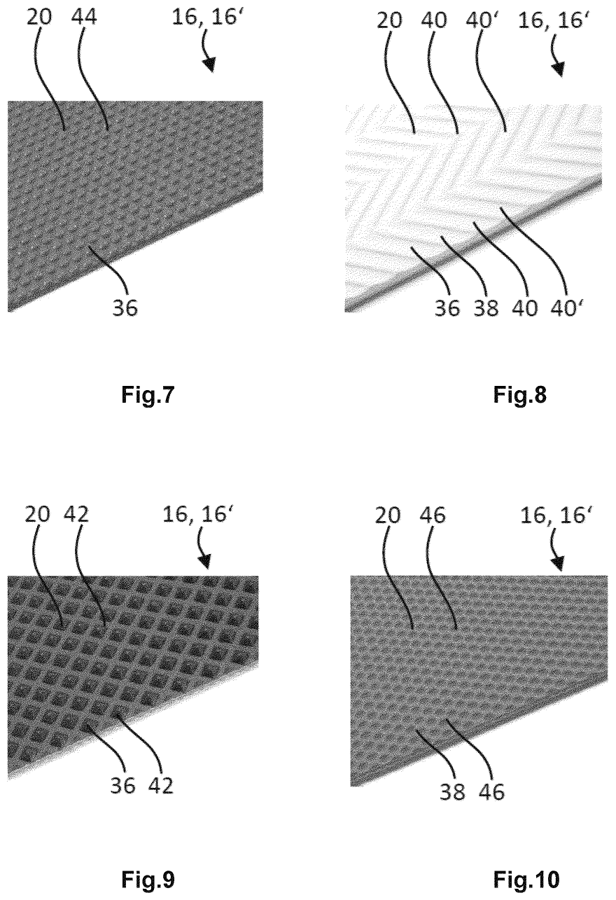

In one embodiment of the invention, feeder element 16, 16′ has a structured surface 20 which preferably forms a support surface having a reduced coefficient of friction for the link of sausages 12. As can be seen from FIGS. 7 to 10, the structured surface 20 has protrusions 36 and/or indentations 38.

As FIGS. 7, 8 and 9 show, protrusions 36 may be in the form, for example, of grooves 40, pyramids 42 or nubs 44 protruding from surface 20. As can be seen from FIGS. 8 and 10, indentations 38 may be in the form of grooves 40′ receding from surface 20, or honeycombs 46 set into the material forming feeder element 16, 16′.

Here, feeder element 16, 16′ is made of a flat belt material, such that the entire feeder element 16, 16′ is concavely funnel-shaped with a width b that decreases in the feeding direction of the link of sausages. Feeder element 16, 16′ may be made of an elastically and/or plastically deformable material, in particular of plastic, stainless steel or a composite material.

In one possible embodiment, surface 20 is provided with a coating that reduces its coefficient of friction, and/or a lubricant is applied to surface 20 during operation. Similar or identical components are marked with the same reference signs.

### LIST OF REFERENCE SIGNS

10, 10′ Feed apparatus
12 Link of sausages
14 Frame
16, 16′ Feeder element
18 Sausages
20 Surface
22 Straight section
24 Peripheral area
26 Twist point
28 Feed hopper
30 Receiving area
32 Dispensing area
34 Wall section
36 Protrusion
38 Indentation
40, 40′ Groove
42 Pyramid
44 Nub
46 Honeycomb
100 Apparatus
102 Conveyor
104, 106 Conveyor element
108 Housing
110 Control unit
112, 112′ Deflection roll
114 Infeed area
A Distance
b Width
F Conveying direction
h Height
L Longitudinal axis
R Radius
QZ Feed cross-section
Z Feeding direction
α Angle of elevation

1. A feed apparatus for feeding a link of sausages composed of a plurality of sausages to a further processing apparatus for further processing the link of sausages, comprising:
a frame, and
a feeder element, arranged on the frame, for feeding the link of sausages to the further processing apparatus, wherein the feeder element has a surface on which the link of sausages lies during operation and is moved in a feeding direction towards the further processing apparatus,
wherein the surface of the feeder element is funnel-shaped and concave, such that the sausages that move in the feeding direction are deflected inwards, relative to the feeding direction, from peripheral areas of the surface, at least in sections.

2. The feed apparatus of claim 1, wherein the peripheral areas of the surface become increasingly steep in the feeding direction, such that the sausages are increasingly deflected inwards radially due to the increasing steepness.

3. The feed apparatus of claim 1, wherein the surface of the feeder element defines a feed cross-section which extends substantially transversely to the feeding direction and which progressively decreases in the feeding direction, at least in sections.

4. The feed apparatus of claim 3, wherein the feed cross-section defined by the surface is substantially U-shaped along at least one section in the feeding direction.

5. The feed apparatus of claim 1, wherein the surface of the feeder element forms an upwardly open feed hopper that narrows in the feeding direction along at least one section in the feeding direction, wherein the surface is substantially step-free.

6. The feed apparatus of claim 3, wherein the feed cross-section defined by the surface of the feeder element is formed at least in some areas by a radius which decreases in the feeding direction.

7. The feed apparatus of claim 3, wherein a width of the surface, measured at its upper boundary, decreases at least in sections in the feeding direction.

8. The feed apparatus of claim 3, wherein the surface has at least one of a substantially straight, a convex, and a concavely curved profile along one section in the feeding direction.

9. The feed apparatus of claim 1, wherein the surface of the feeder element defines, at least in sections, a first receiving area in the feeding direction for depositing the link of sausages.

10. The feed apparatus of claim 9, wherein the receiving area is substantially planar or has a concave curvature, at least transversely to the feeding direction, which preferably has a radius greater than 1 meter.

11. The feed apparatus of claim 9, wherein the surface defines a dispensing area for dispensing the link of sausages and which has a smallest width or a smallest feed cross-section.

12. The feed apparatus of claim 11, wherein two lateral wall sections extending substantially parallel to each other are provided in the dispensing area in addition to the concave curvature of the surface.

13. The feed apparatus of claim 12, wherein the wall sections are spaced apart from each other by a distance that is greater than a diameter of the sausages and less than the center-to-center distance between two conveyor elements of a conveyor of the further processing apparatus, which define an infeed area for the link of sausages to the further processing apparatus.

14. The feed apparatus of claim 11, wherein the surface of the feeder element rises from the first receiving area in a direction of the dispensing area.

15. The feed apparatus of claim 1, wherein the feeder element has a structured surface which forms a support surface having a reduced coefficient of friction for the link of sausages, and wherein the structured surface has at least one of protrusions and indentations.

16. The feed apparatus of claim 1, wherein the surface has structurations, selected from a group consisting of: honeycombs, grooves, pyramids, nubs, and combinations thereof.

17. The feed apparatus of claim 1, wherein the surface is provided with a coating or lubricant that reduces its coefficient of friction during operation.

18. The feed apparatus of claim 1, wherein the feeder element is made of a flat belt material, wherein the entire feeder element is designed in the shape of a funnel with a width that decreases in the feeding direction of the link of sausages.

19. The feed apparatus of claim 1, wherein the feeder element is made of an elastically and/or plastically deformable material, and the feeder element is made of at least one of plastic, stainless steel, and a composite material.

20. An apparatus for further processing a link of sausages, comprising:
at least one conveyor which takes delivery of the link of sausages and conveys them in a conveying direction, and
the feed apparatus of claim 1, the feed apparatus being arranged upstream from the conveyor.
